(19) United States
(12) Patent Application Publication
(10) Pub. No.: US 2018/0223104 A1
(43) Pub. Date: Aug. 9, 2018

(54) COMPOSITIONS AND METHODS FOR REDUCING OR EXTENDING TITANIUM DIOXIDE IN PAPER

(71) Applicant: Imerys USA, Inc., Roswell, GA (US)

(72) Inventors: David STEWART, Alpharetta, GA (US); Christopher HOLMES, Exeter (GB)

(73) Assignee: Imerys USA, Inc., Roswell, GA (US)

(21) Appl. No.: 15/580,767

(22) PCT Filed: Jun. 8, 2016
(86) PCT No.: PCT/US16/36453

§ 371 Date: Dec. 8, 2017

Related U.S. Application Data
(60) Provisional application No. 62/173,219, filed on Jun. 9, 2015.

(51) Int. Cl. C09C 1/00; B32B 15/12; B32B 29/06

(52) U.S. Cl. CPC C09C 1/0087; B32B 15/12; C09C 1/42; B32B 2451/00; C01P 2006/10; B32B 29/06

(57) ABSTRACT

A method may be used for reducing titanium dioxide in a composition for forming decorative paper for use in laminated products. The method may include providing a pigment composition including titanium dioxide, and combining the pigment composition with a titanium dioxide extender including at least two particulate minerals to form a combined pigment composition. The titanium dioxide extender may include diatomaceous earth and at least one of aluminosilicate and talc. Combining the pigment composition with the titanium dioxide extender may result in reducing the titanium dioxide by at least 10% while substantially maintaining at least one of whiteness, wet whiteness, brightness, wet brightness, opacity, wet opacity, and resin impregnation of the decorative paper produced including the titanium dioxide extender relative to the decorative paper produced with the titanium dioxide but without the titanium dioxide extender.

### CLAIM OF PRIORITY

This PCT International Application claims the benefit of priority of U.S. Provisional Application No. 62/173,219, filed Jun. 9, 2015, the subject matter of which is incorporated herein by reference in its entirety.

### FIELD OF THE DESCRIPTION

The present disclosure relates to compositions and methods for reducing or extending titanium dioxide in paper, and more particularly, to compositions and methods for reducing or extending titanium dioxide in decorative paper for use in laminated products.

### BACKGROUND

Compositions for making paper often include pigment compositions for providing desired visual characteristics of the paper. For example, pigment compositions may be used to provide or enhance the desired whiteness, brightness, and/or opacity of the paper. Titanium dioxide (TiO₂) may be used as a filler or pigment for paper compositions due to its advantageous scattering and opacifying characteristics. However, titanium dioxide is expensive, and thus, it may be desirable to replace some of the titanium dioxide in such compositions in order to reduce costs. In addition, increased concern over global warming and greenhouse gases has led to increased customer demand for products having a lower carbon footprint. Titanium dioxide has a relatively high carbon footprint, and thus, it may be desirable to reduce the quantity of titanium dioxide used in paper, thereby providing production of more environmentally friendly paper.

Decorative laminate paper, sometimes referred to as “décor paper,” is an example of paper where whiteness, brightness, and/or opacity are often desirable characteristics of the paper. Décor paper is often used as a laminate for such laminated items as wall panels, furniture, edgeband, foil papers, trim, backer papers and the like. Décor paper is often provided with a printed simulation of a natural material, such as wood grain and stone patterns, and may be incorporated into a laminated building material for improving the aesthetics of surfaces, such as walls, countertops, and furniture. Many types of décor paper include titanium dioxide to provide desired properties, such as, for example, whiteness, brightness, and opacity, as well as resin impregnation due to its incorporation into a laminated product. For the reasons noted above, it may be desirable to reduce the amount of titanium dioxide in a pigment composition used to prepare décor paper, or substitute one or more other pigment composition constituents for at least some of the titanium dioxide, while substantially maintaining the characteristics customarily provided by the titanium dioxide.

Some embodiments of the compositions and methods of the present disclosure may be directed to reducing or extending titanium dioxide in compositions for making paper.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to a first aspect, a method for reducing titanium dioxide in a composition for forming decorative paper for use in laminated products, may include providing a pigment composition including titanium dioxide, and combining the pigment composition with a titanium dioxide extender including at least two particulate minerals to form a combined pigment composition. The titanium dioxide extender may include diatomaceous earth and at least one of aluminosilicate and talc, and blending the pigment composition with the titanium dioxide extender may result in reducing the titanium dioxide by at least 10% while substantially maintaining at least one of whiteness, brightness, wet brightness, opacity, wet opacity, and resin impregnation of the decorative paper produced including the titanium dioxide extender relative to the decorative paper produced with the titanium dioxide but without the titanium dioxide extender.

According to yet another aspect, a composition for forming decorative paper for use in laminated products may include titanium dioxide, wherein the titanium dioxide comprises from 10% to 35% by weight of the composition. The composition may also include titanium dioxide extender, wherein the titanium dioxide extender includes diatomaceous earth and at least one of aluminosilicate and talc, and wherein the titanium dioxide extender comprises from 1% to 10% by weight of the composition.

According to still another aspect, decorative paper may include the composition including titanium dioxide and the titanium dioxide extender. According to still another aspect, a laminated product may include the decorative paper.

Exemplary objects and advantages will be set forth in part in the description which follows, or may be learned by practice of the exemplary embodiments. It is to be understood that both the foregoing general description and the following detailed description are exemplary and explanatory only and are not restrictive of the invention, as claimed.

The accompanying drawings, which are incorporated in and constitute a part of this specification, illustrate exemplary embodiments and together with the description, may serve to explain some principles of the invention.

### BRIEF DESCRIPTION OF THE DRAWINGS

FIG. 1 shows exemplary embodiments of laminated products that incorporate therein exemplary decorative papers.

FIG. 2 shows an exemplary embodiment of a laminated product including an overlay paper, impregnated decorative paper, a substrate material, and backer paper.

FIG. 3 is a schematic diagram showing an exemplary process for manufacturing an exemplary pulp for use in decorative paper.

FIG. 4 shows filler-retention versus tensile-index versus ash content for control sample A and exemplary samples B-F.

FIG. 5 shows opacity (dry) versus tensile-index versus ash content for control sample A and exemplary samples B-F.

FIG. 6 shows wet opacity versus tensile-index versus ash content for control sample A and exemplary samples B-F.

### DETAILED DESCRIPTION

According to some embodiments, a method may be used for reducing titanium dioxide in a composition for forming decorative paper for use in laminated products. The method may include providing a pigment composition including titanium dioxide and combining the pigment composition with a titanium dioxide extender including at least two particulate minerals to form a combined pigment composition. The titanium dioxide extender may include diatomaceous earth and at least one of aluminosilicate and talc. Combining the pigment composition with the titanium dioxide extender may result in reducing the titanium dioxide by at least 10% while substantially maintaining at least one of whiteness, brightness, wet brightness, opacity, wet opacity, and resin impregnation of the decorative paper produced including the titanium dioxide extender relative to the decorative paper produced with the titanium dioxide but without the titanium dioxide extender. For example, the titanium dioxide extender may be substituted for at least some of the titanium dioxide, such that the combined pigment composition includes less titanium dioxide while substantially maintaining at least one of whiteness, wet whiteness, brightness, wet brightness, opacity, wet opacity, and resin impregnation of the decorative paper produced including the reduced amount of titanium dioxide and the titanium dioxide extender, relative to the decorative paper produced with the full amount of titanium dioxide but without the titanium dioxide extender.

In some embodiments, the pigment composition can also include additional diatomaceous earth, such as for example flux calcined diatomaceous earth, other than what is present in the titanium dioxide extender.

According to some embodiments, the combined pigment composition with the titanium dioxide extender may result in reducing by 5% or less, 4% or less, 3% or less, 2% or less, or 1% or less at least one of whiteness, brightness, wet brightness, opacity, wet opacity, and resin impregnation of the decorative paper produced including the titanium dioxide extender relative to the decorative paper produced with the titanium dioxide (and optionally additional diatomaceous earth) but without the titanium dioxide extender. For example, the combined pigment composition with the titanium dioxide extender may result in reducing by 5% or less, 4% or less, 3% or less, 2% or less, or 1% or less the wet opacity of the decorative paper produced including the titanium dioxide extender relative to the decorative paper produced with the titanium dioxide but without the titanium dioxide extender.

According to some embodiments, combining the pigment composition with the titanium dioxide extender may result in reducing the titanium dioxide by at least 15% while substantially maintaining at least one of the whiteness, brightness, wet brightness, opacity, wet opacity, and resin impregnation of the decorative paper produced including the titanium dioxide extender relative to the decorative paper produced with the titanium dioxide but without the titanium dioxide extender. For example, combining the pigment composition with the titanium dioxide extender may result in reducing the titanium dioxide by at least 20% while substantially maintaining at least one of the whiteness, brightness, wet brightness, opacity, wet opacity, and resin impregnation of the decorative paper produced including the titanium dioxide extender relative to the decorative paper produced with the titanium dioxide but without the titanium dioxide extender.

According to some embodiments, the aluminosilicate may include kaolin. For example, the aluminosilicate may include one or more of calcined kaolin and flash-calcined kaolin. According to some embodiments, the titanium dioxide extender may include diatomaceous earth and talc. For example, the titanium dioxide extender may include diatomaceous earth, aluminosilicate, and talc. According to some embodiments, the diatomaceous earth may be a natural diatomaceous earth and/or a diatomaceous earth that has not been calcined.

According to some embodiments, the titanium dioxide extender may comprise from 10% to 40% by weight of the combined pigment composition. According to some embodiments, the titanium dioxide extender may comprise from 10% to 20% by weight of the combined pigment composition. According to some embodiments, the titanium dioxide may comprise from 80% to 85% by weight of the combined pigment composition, and the titanium dioxide extender may comprise from 15% to 20% by weight of the combined pigment composition. According to some embodiments, the titanium dioxide extender may comprise from 10% to 15% by weight of the combined pigment composition. According to some other embodiments, the titanium dioxide may comprise from 80% to 85% by weight of the combined pigment composition, and the titanium dioxide extender may comprise from 20% to 40% by weight of the combined pigment composition.

According to some embodiments, the titanium dioxide extender can include a ratio by weight of diatomaceous earth to the at least one of aluminosilicate and talc of at least 10:90. For example, the ratio by weight of diatomaceous earth to the at least one of aluminosilicate and talc can be at least 20:80, at least 30:70, at least 40:60, at least 50:50, at least 60:40, at least 70:30, at least 80:20, or at least 90:10. According to some embodiments, the ratio of by weight of the diatomaceous earth to the at least one of aluminosilicate and talc ranges from 10:90 to 90:10. According to some embodiments, the ratio by weight of diatomaceous earth to the at least one of aluminosilicate and talc ranges from 20:80 to 80:20. According to some embodiments, the ratio by weight of the diatomaceous earth to the at least one of aluminosilicate and talc ranges from 30:70 to 70:30, from 40:60 to 60:40, from 10:90 to 50:50, or from 10:90 to 40:60.

According to some embodiments, a composition for forming decorative paper for use in laminated products may include titanium dioxide, wherein the titanium dioxide may comprise from 10% to 35% by weight of the composition for forming decorative paper. The composition may also include titanium dioxide extender, the titanium dioxide extender may comprise diatomaceous earth and at least one of aluminosilicate and talc, and the titanium dioxide extender may comprise from 1% to 10% by weight of the composition.

According to some embodiments, the titanium dioxide may comprise from 15% to 35% by weight of the decorative paper forming composition, and the titanium dioxide extender may comprise from 1% to 6% by weight of the decorative paper forming composition. According to some embodiments, the titanium dioxide may comprise from 20% to 30% by weight of the decorative paper forming composition, and the titanium dioxide extender may comprise from 3% to 6% by weight of the decorative paper forming composition.

According to some embodiments, the titanium dioxide and the titanium dioxide extender may comprise a pigment composition, wherein the titanium dioxide may comprise from 75% to 90% by weight of the pigment composition, and the titanium dioxide extender may comprise from 10% to 25% by weight of the pigment composition. According to some embodiments, the titanium dioxide may comprise from 80% to 90% by weight of the pigment composition, and the titanium dioxide extender may comprise from 10% to 20% by weight of the pigment composition. According to some embodiments, the titanium dioxide may comprise from 80% to 85% by weight of the pigment composition, and the titanium dioxide extender may comprise from 15% to 20% by weight of the pigment composition. According to some embodiments, the titanium dioxide may comprise from 85% to 90% by weight of the pigment composition, and the titanium dioxide extender may comprise from 10% to 15% by weight of the pigment composition.

According to some embodiments, the titanium dioxide extender composition includes a ratio by weight of diatomaceous earth to the at least one of aluminosilicate and talc of at least 10:90. For example, the ratio by weight of the diatomaceous earth to the at least one of aluminosilicate and talc is at least 20:80, at least 30:70, at least 40:60, at least 50:50, at least 60:40, at least 70:30, at least 80:20, or at least 90:10. According to some embodiments, the ratio of by weight of the diatomaceous earth to the at least one of aluminosilicate and talc ranges from 10:90 to 90:10. According to some embodiments, the ratio by weight of the diatomaceous earth to the at least one of aluminosilicate and talc ranges from 20:80 to 80:20. According to some embodiments, the ratio by weight of the diatomaceous earth to the at least one of aluminosilicate and talc ranges from 30:70 to 70:30, from 40:60 to 60:40, from 10:90 to 50:50, or from 10:90 to 40:60.

According to some embodiments of the composition, the aluminosilicate may include kaolin. For example, the aluminosilicate may include one or more of calcined kaolin and flash-calcined kaolin. According to some embodiments of the composition, the titanium dioxide extender may include diatomaceous earth and talc. For example, the titanium dioxide extender may include diatomaceous earth, aluminosilicate, and talc. According to some embodiments, the diatomaceous earth may be a natural diatomaceous earth and/or a diatomaceous earth that has not been calcined.

A laminated product may include the decorative paper disclosed herein. For example, the laminated product may include a laminated building material for improving the aesthetics of surfaces, such as, for example, walls, countertops, and furniture.

According to some embodiments, decorative laminate paper may take the form of a high quality specialty paper configured to upgrade or enhance the surface of wood-based panels, such as, for example, particle board and/or medium density fiberboard (MDF). Some examples of end uses include furniture manufacturing, interior and exterior architecture products, and laminate flooring.

According to some embodiments, the decorative paper may include (1) short fibers, such as, for example, hardwood (e.g., eucalyptus) to provide high tensile strength and a smooth surface; and (2) long fibers, such as, for example, soft wood (e.g., pine and/or fir) to provide tear resistance. The fibers may be combined with a pigment composition and/or pigment extender composition to provide a desired opacity. The amount of pigment and/or pigment extender may vary from about 4% to about 40% by weight, with titanium dioxide and extenders accounting for a major portion (e.g., all) of the pigment composition and/or pigment extender composition.

According to some embodiments, the production process may be tailored depending on the desired decorative paper. For example, the desired decorative paper may range from, for example, unicolor high-pressure laminates or low-pressure laminate printbase papers, to finished foils for furniture, to edgebanding, and release papers. Depending on the desired decorative paper, surface finishes may be machine-smoothed, glazed, or machine glazed, and the paper may be configured to have predetermined resin absorption properties.

According to some embodiments, the decorative paper may be printed to achieve desired visual characteristics, such as, for example, a simulated wood, stone, or other natural-appearing finish. Gravure printing may be used.

Because the decorative paper may be used in laminates, the resin impregnation characteristic may be important. For example, according to some embodiments, the resin may include about 25% to 40% by weight of urea formaldehyde, melamine formaldehyde, and/or acrylate or phenolic formaldehyde, and the resin may be used to fully saturate the decorative paper before drying.

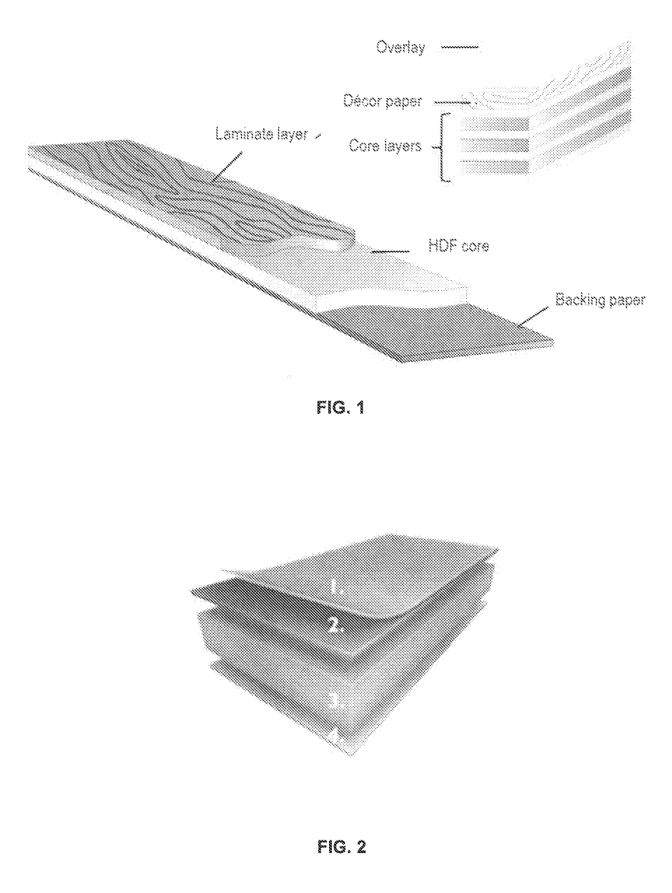

FIG. 1 shows exemplary embodiments of laminated products that incorporate therein exemplary decorative papers. Low-pressure laminate is often used for furniture components or laminate flooring. High-pressure laminate is a more robust, heavy-duty product that is often used for kitchen worktops, door leaves, and exterior facades. According to some embodiments, core papers are impregnated with phenolic resin, and melamine-impregnated paper is pressed onto the core papers to form a surface layer. This may later be bonded onto a substrate or used directly as a so-called “compact board.” Foils and edgebanding may be impregnated with acrylate resin mixtures and then lacquered and bonded onto the substrate.

According to some embodiments, decorative paper (e.g., décor paper) may be printed by the producer of the paper, and the paper may be printed wood, stone, or colored pattern effects. According to some embodiments, both printed and non-printed decorative paper may be impregnated with melamine resin. After impregnation, the resulting intermediate product may be laminated onto a wood-based substrate, such as, for example, medium density fiberboards (MDF) and/or particleboard. Pre-impregnated decorative paper may not be laminated, but rather, may be glued onto the wood-based substrate. As shown in FIG. 2, an overlay paper 1, impregnated decorative paper 2, a substrate material 3, and backer paper 4 may be laminated to one another.

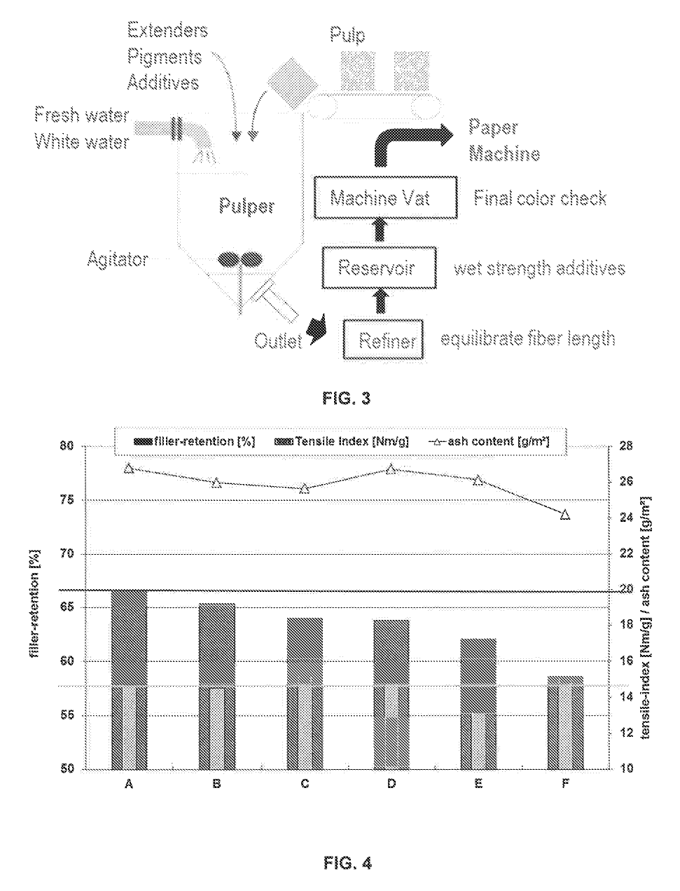

FIG. 3 is a schematic diagram showing an exemplary process for manufacturing an exemplary decorative paper (e.g., décor paper). According to some embodiments, a 1% solids slurry is sprayed onto an endless “wire” and de-watered to achieve a 50-60% solids slurry via drainage and vacuum. A higher concentration of fillers and fines remains in the top layer of the web. According to some embodiments, the web may be subjected to further processing through rollers, cylinders, and/or presses to dry and condition the web.

There may be certain attributes desirable for decorative paper (e.g., décor paper), such as, for example, the decorative paper may be formed to have sufficient opacity to render it opaque, so the mottled appearance of the lower layer in the laminate does not show through. In addition, it may be desirable for the surface to be printable, so that wood, stone, and/or other effects may be simulated using, for example, gravure printing. For example, the surface may be configured to achieve good contact between the substrate and print cylinders, which may be achieved by smoothness and compressibility. In addition, it may be desirable to be able to impregnate the paper with the appropriate resin.

There may be certain attributes desirable for finished decorative paper laminate, such as, for example, the ability to adhere various films to the substrate; resistance to ultra-violet light, chemicals, and/or cleaning agents; and good mechanical resistance (e.g., scratch-resistance). It may also be desirable for the decorative paper, prior to being impregnated with resin, to have the following properties: a density (dry) of 55 grams per square meter (gsm); an ash content (i.e., amount of inorganic fillers/pigments) as measured according to ISO 2144:1997 of 14.6% by weight; an opacity (dry) measured according to ISO 2471 of 91.4% (i.e., the light transparency degree of the paper expressed as a percentage in relation to the reflected light); a whiteness (dry) measured according to ISO 2470 of 64.5 (i.e., the subjectively perceived property (blue tone being perceived to have better whiteness)); and brightness measured according to ISO 2470 of 82.1% (i.e., the reflection of blue light expressed as a percentage as compared to a standard reference).

It may also be desirable for the decorative paper, after impregnation and calendering, to have the following properties: an opacity (wet) measured according to ISO 2471 of 88.1%; a Bekk smoothness measured according to ISO 5627:1995 of 120 (i.e., a measurement of macro surface roughness with the higher the number the smoother the surface (alternative is Parker Print Surf test as measured according to ISO 8791-4)); a Bendtsen porosity measured according to ISO 5636-3 of 105 milliliters per minute (i.e., provides crude indication of porosity which may correlate to impregnation); a whiteness (wet) measured according to ISO 2470 of 60.1; a brightness (wet) measured according to ISO 2470 of 79%; and a pH measured according to ISO 6588 of 6.9 (e.g., for print quality).

### Examples

A control pigment composition sample A and five exemplary pigment composition samples B-F including titanium dioxide extender for use in decorative paper compositions were prepared and tested in decorative paper samples formed including the sample compositions. The control sample A composition included a conventional pigment composition including titanium dioxide (TiO₂) and a flux-calcined diatomaceous earth, at a ratio of roughly 70:30 of titanium dioxide to flux-calcined diatomaceous earth, but no titanium dioxide extender. For composition samples B-F, the amount of titanium dioxide and flux-calcined diatomaceous earth was decreased in 5% increments and replaced with a titanium dioxide extender in the form of an exemplary engineered titanium dioxide extender blend of calcined kaolin and natural (uncalcined) diatomaceous earth, at a ratio of 70:30 of calcined kaolin to natural diatomaceous earth. Table 1 below shows the content, properties, and test results of the control sample A and exemplary samples B-F.

TABLE 1

| | | 1 | 2 | 3 | 4 | 5 | 6 |
|---|---|---|---|---|---|---|---|
| Trial point | | | | | | | |
| TiO₂ | [%] | 71.4 | 67.9 | 64.3 | 60.7 | 57.1 | 53.6 |
| Flux Calcined DE | [%] | 28.6 | 27.1 | 25.7 | 24.3 | 22.9 | 21.4 |
| TiO2 Extender | [%] | 0 | 5 | 10 | 15 | 20 | 25 |
| Dry data | | | | | | | |
| Grammage | [g/m²] | 80.4 | 79.5 | 80.2 | 80 | 80.4 | 78.8 |
| Thinkness | [μm] | 140 | 141 | 143 | 144 | 145 | 145 |
| Density | [g/cm³] | 0.57 | 0.56 | 0.56 | 0.56 | 0.55 | 0.54 |
| Air permeability | [s/100 cm³] | 2.37 | 2.47 | 2.62 | 2.76 | 2.80 | 3.00 |
| (Gurley) | | | | | | | |
| Extension | [%] | 1.76 | 1.82 | 1.78 | 1.78 | 1.64 | 1.72 |
| Tensile strength | [N] | 17.56 | 17.46 | 18.37 | 17.7 | 15.78 | 18.14 |
| Tensile-Index | [Nm/g] | 14.61 | 14.53 | 15.25 | 14.75 | 13.17 | 15.08 |
| Filler retention | [%] | 66.6 | 65.4 | 64.0 | 63.8 | 62.0 | 58.6 |
| Ash 900° C. | [%] | 33.3 | 32.68 | 31.98 | 33.41 | 32.49 | 30.69 |
| Ash content | g/m² | 26.8 | 26.0 | 25.6 | 26.7 | 26.1 | 24.2 |
| Wet data | | | | | | | |
| Wet tensile | [N] | 3.78 | 3.87 | 3.75 | 2.74 | 2.68 | 2.83 |
| strength | | | | | | | |
| Wet extension | [%] | 4.93 | 4.62 | 4.35 | 3.44 | 3.65 | 3.56 |
| Grammage | [g/m²] | 78.9 | 78.7 | 79.8 | 78.6 | 78.2 | 79.6 |
| Brightness | [%] | 91.25 | 91.01 | 90.92 | 90.69 | 90.46 | 89.90 |
| Opacity | [%] | 94.95 | 94.61 | 94.88 | 95.05 | 95.43 | 95.08 |
| Light scattering | s-[cm²/g] | 129.6 | 125.3 | 126.2 | 127.2 | 130.4 | 122.1 |
| coefficient | | | | | | | |
| Ligth absorbtion | k-[cm²/g] | 0.16 | 0.17 | 0.18 | 0.19 | 0.21 | 0.23 |
| coefficient | | | | | | | |
| Wet opacity | [%] | 80.93 | 79.93 | 79.87 | 79.67 | 80.02 | 78.97 |
| Ash 900° C. | [%] | 30.8 | 30.4 | 29.7 | 30.4 | 30.8 | 28.4 |
| Ash content | g/m² | 24.3 | 23.9 | 23.7 | 23.9 | 24.1 | 22.6 |

The samples were incorporated into handsheets for testing. The handsheets were formed having a targeted substance of 80 grams per square meter (gsm), and the pulp used was 100% eucalyptus. The handsheets were formed by beating the eucalyptus pulp and adding the pulp to ⅔ wet strength agents (epichlorohydrinresin), which was processed in a mixer including titanium dioxide, and the pH was adjusted to 6.5. The titanium dioxide of the formed handsheets for control sample A was about 35% by weight. The titanium dioxide was prepared as a 50% slurry with a pH adjusted to 9.0 to 9.5 with NaOH. The flux-calcined diatomaceous earth was prepared as a 25% slurry. The titanium dioxide extender blend of calcined kaolin and natural (uncalcined) diatomaceous earth was also prepared as a 25% slurry.

The properties tested were handsheet (DIN 54 358-1); grammage and thickness (DIN EN ISO 536 and DIN EN ISO 534); tensile strength, elastic modulus, and extension (DIN EN 1924-2); wet tensile strength (DIN ISO 3781); light scattering coefficient s (DIN 54 500 and ISO 9416); light absorption coefficient k (DIN 54 500 and ISO 9416); opacity (DIN 53 146); brightness (DIN 53 145-1); and ash (DIN 54 370 and ISO 2144). The compression of the handsheets and measuring of the wet opacity was carried out in a paper mill.

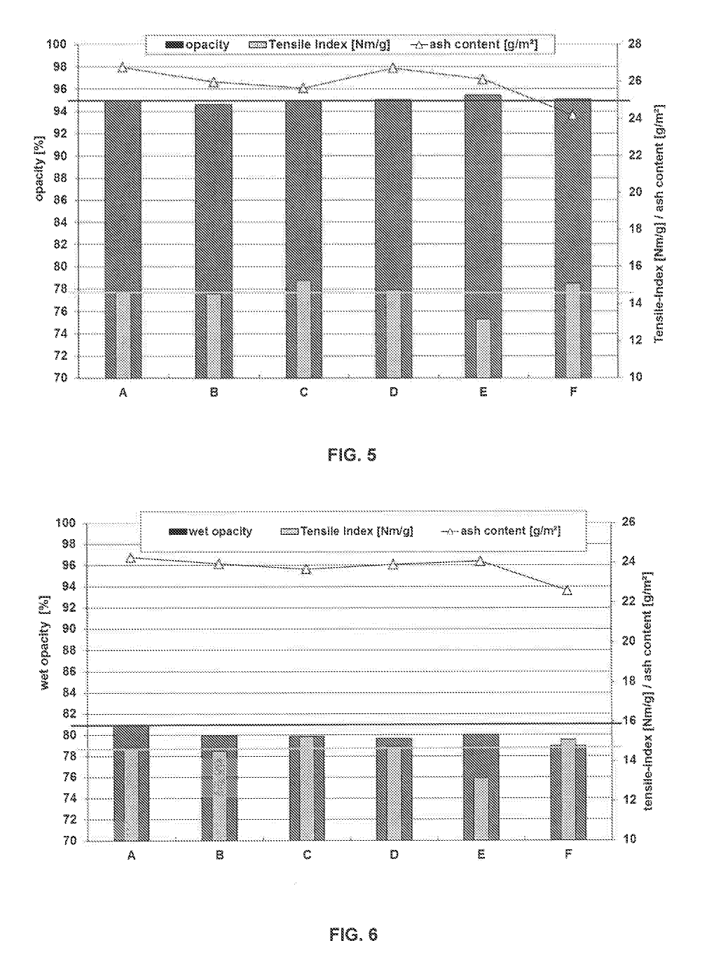

FIG. 4. shows filler-retention versus tensile-index versus ash content for the six samples, including the control sample A and exemplary samples B-F. FIG. 5 shows opacity versus tensile-index versus ash content for the six samples. To summarize, the samples had the following content:
A. Control Sample A: 71.4% titanium dioxide, 28.6% flux-calcined diatomaceous earth, and 0% titanium dioxide extender,
B. Sample B: 67.9% titanium dioxide, 27.1% flux-calcined diatomaceous earth, and 5% titanium dioxide extender;
C. Sample C: 64.3% titanium dioxide, 25.7% flux-calcined diatomaceous earth, and 10% titanium dioxide extender;
D. Sample D: 60.7% titanium dioxide, 24.3% flux-calcined diatomaceous earth, and 15% titanium dioxide extender;
E. Sample E: 57.1% titanium dioxide, 22.9% flux-calcined diatomaceous earth, and 20% titanium dioxide extender; and
F. Sample F: 53.6% titanium dioxide, 21.4% flux-calcined diatomaceous earth, and 25% titanium dioxide extender.

As shown by the test results, the filler retention decreased with the increase in the blended titanium dioxide extender. The test results also show that the optical properties were not significantly affected by incorporation of the extender into the paper making compositions (i.e., the substitution of the titanium dioxide extender for the titanium dioxide and flux-calcined diatomaceous earth). Similarly, the test results also show that the strength properties of the handsheets were not significantly affected by incorporation of the extender into the paper making compositions. Also, the wet opacity was only reduced by a maximum of less than about 2% by incorporation of the extender into the paper making compositions (i.e., a maximum drop from 80.93% for control sample A to 78.97% for exemplary sample F).

Other embodiments will be apparent to those skilled in the art from consideration of the specification and practice of the embodiments disclosed herein. It is intended that the specification and examples be considered as exemplary only.

1. A method for reducing titanium dioxide in a composition for forming decorative paper for use in laminated products, the method comprising:
providing a pigment composition comprising titanium dioxide; and
combining the pigment composition with a titanium dioxide extender comprising at least two particulate minerals to form a combined pigment composition,
wherein the titanium dioxide extender comprises diatomaceous earth and at least one of aluminosilicate and talc, and
wherein combining the pigment composition with the titanium dioxide extender results in reducing the titanium dioxide by at least 10% while substantially maintaining at least one of whiteness, brightness, wet brightness, opacity, wet opacity, and resin impregnation of the decorative paper produced including the titanium dioxide extender relative to the decorative paper produced with the titanium dioxide but without the titanium dioxide extender.

2. The method of claim 1, wherein combining the pigment composition with the titanium dioxide extender results in reducing the titanium dioxide by at least 15% while substantially maintaining at least one of the whiteness, brightness, wet brightness, opacity, wet opacity, and resin impregnation of the decorative paper produced including the titanium dioxide extender relative to the decorative paper produced with the titanium dioxide but without the titanium dioxide extender.

3. (canceled)

4. The method of claim 1, wherein the aluminosilicate comprises kaolin.

5. The method of claim 1, wherein the aluminosilicate comprises calcined kaolin.

6. The method of claim 1, wherein the aluminosilicate comprises flash-calcined kaolin.

7. The method of claim 1, wherein the titanium dioxide extender comprises talc.

8. The method of claim 1, wherein the titanium dioxide extender comprises aluminosilicate and talc.

9. The method of claim 1, the titanium dioxide extender comprises from 10% to 25% by weight of the combined pigment composition.

10. The method of claim 1, wherein the titanium dioxide comprises from 80% to 90% by weight of the combined pigment composition, and the titanium dioxide extender comprises from 10% to 20% by weight of the combined pigment composition.

11-16. (canceled)

17. The method of claim 1, wherein a ratio by weight of the titanium dioxide extender of the diatomaceous earth to the at least one of aluminosilicate and talc ranges from 10:90 to 90:10.

18-19. (canceled)

20. A composition for forming decorative paper for use in laminated products, the composition comprising:
titanium dioxide, wherein the titanium dioxide comprises from 10% to 35% by weight of the composition; and
titanium dioxide extender, wherein the titanium dioxide extender comprises diatomaceous earth and at least one of aluminosilicate and talc, and wherein the titanium dioxide extender comprises from 1% to 10% by weight of the composition.

21. The composition of claim 20, wherein the titanium dioxide comprises from 15% to 35% by weight of the composition, and wherein the titanium dioxide extender comprises from 1% to 6% by weight of the composition.

22. (canceled)

23. The composition of claim 20, wherein the titanium dioxide and the titanium dioxide extender comprise a pigment composition, wherein the titanium dioxide comprises from 75% to 90% by weight of the pigment composition, and the titanium dioxide extender comprises from 10% to 25% by weight of the pigment composition.

24-30. (canceled)

31. The composition of claim 20, wherein a ratio by weight of the titanium dioxide extender of the diatomaceous earth to the at least one of aluminosilicate and talc ranges from 10:90 to 90:10.

32-33. (canceled)

34. The composition of claim 20, wherein the aluminosilicate comprises kaolin.

35. The composition of claim 20, wherein the aluminosilicate comprises calcined kaolin.

36. The composition of claim 20, wherein the aluminosilicate comprises flash-calcined kaolin.

37. The composition of claim 20, wherein the titanium dioxide extender comprises talc.

38. The composition of claim 20, wherein the titanium dioxide extender comprises aluminosilicate and talc.

39. Decorative paper comprising the composition of claim 20.

40-42. (canceled)
